(19) United States
(12) Patent Application Publication
(10) Pub. No.: US 2026/0011086 A1
(43) Pub. Date: Jan. 8, 2026

(54) OMNIDIRECTIONAL TREADMILL

(71) Applicant: Marvin FACHTNER, Stralsund (DE)

(72) Inventor: Marvin FACHTNER, Stralsund (DE)

(21) Appl. No.: 19/259,127

(22) Filed: Jul. 3, 2025

Related U.S. Application Data
(63) Continuation of application No. PCT/DE2023/000137, filed on Oct. 11, 2023.
(60) Provisional application No. 63/437,790, filed on Jan. 9, 2023.

(51) Int. Cl. G06T 19/00; A63B 22/02

(52) U.S. Cl. CPC G06T 19/00; A63B 2022/0271; A63B 22/0285

(57) ABSTRACT

An omnidirectional treadmill device for supporting a VR experience includes a concave platform having a regular array of apertures in which ball bearing elements are installed, the array extending across the upper surface of the platform. The platform is supported by a frame connected to a freely rotatable body support to hold a user in a position above a central point of the platform. The combined use of the concave, ball-bearing covered platform and the body support allows the user freedom of movement in a way that allows their feet to roll on the floor of the platform in a way that feels natural. The user's movements are tracked and converted into joystick movements for the VR application.

### CROSS REFERENCE TO RELATED APPLICATIONS

This application is a continuation of and Applicant claims priority under 35 U.S.C. § 120 of International Application No. PCT/DE2023/000137 filed Oct. 11, 2023, which claims priority under 35 U.S.C. § 119 (e) from U.S. Provisional Patent Application Ser. No. 63/437,790 filed Jan. 9, 2023, the disclosures of each of which are hereby incorporated by reference. The international application under PCT article 21(2) was not published in English.

### BACKGROUND OF THE INVENTION

### 1. Field of the Invention

The present invention relates to an omnidirectional treadmill apparatus. More specifically, the present invention relates to an omnidirectional treadmill configured to provide the most seamless 360-degree movement of a user to support a VR experience.

### 2. Description of the Related Art

The development of virtual reality (VR) technology has accelerated greatly in recent years, with the result that VR headsets such as the Oculus Quest are now relatively widespread. There is also a thriving community of VR enthusiasts who want to enhance their VR experience with various accessories.

Despite the rapid development of the technology, there are still obstacles that prevent VR from becoming truly immersive and dominating the console market. For example, while putting on a VR headset for the first time is a magical experience for many users, this experience is often quickly dampened if they suffer from ‘motion sickness’. It is believed that motion sickness in VR is at least partly due to the fact that the joystick of a controller is used to move in a certain direction in VR, while the user's body is actually just standing still.

### SUMMARY OF THE INVENTION

To solve this problem, omnidirectional treadmills have been proposed. By physically walking on a treadmill to create a corresponding movement of the user in virtual reality, the discrepancy between the virtual world and the real world that causes motion sickness is reduced and the overall immersion in the VR experience can be greatly increased. An omnidirectional treadmill is a device that allows the user to walk or run in any direction while remaining stationary in space.

Various omnidirectional treadmills have been proposed in the state of the art, and some are already available on the market. Many of them use mechanical parts that actually move with the user's feet. Such designs are often expensive and have problems with inertia, as the moving parts cannot stop at the exact moment the user wants to stop. To do this, the treadmill would have to be able to anticipate the user's thoughts/intention. As this is not yet possible, the user is moved a little further than intended. This then has to be compensated for and leads to unpleasant corrective movements. In other designs, platforms with low-friction surfaces are combined with special low-friction shoes that allow the user to slide their feet backwards over the platform to imitate the walking movement. For the user, this feels more like sliding than walking, and they have to put on special shoes to use the treadmill. In addition, this method is usually very noisy.

Freely rotating elements on a platform that roll in their mounts underneath the foot when the user places their feet on them would solve both of the above mentioned problems and make it easier for the user to control the acceleration and speed of their movements while maintaining a relatively natural gait. Theoretically, this would be possible without special footwear. However, the sole should not have a deep profile, otherwise you could get stuck between the balls.

Two types of rolling omnidirectional treadmills have been proposed in the prior art. Treadmills consisting of several freely rotating cylinders and platforms covered with rotating balls/spheres. The cylindrical geometry is not truly omnidirectional, as the cylinders are each limited to a single axis of rotation along their length. This reduces the quality of movement the user experiences when dragging their feet across the cylinders. In fact, this would not work at all with the proposed form factor of the device, as with every step you would be trying to make cylinders rotate against their axis of rotation. As this is not possible, you would get “stuck” there.

The spherical geometry appears to be the most effective solution. Prior art solutions such as KR-10-2015-0128184 and U.S. Pat. No. 10,101,805 propose the use of spheres. However, the proposed concepts have fundamental problems that make practical implementation impossible. They include central areas in their platforms that are completely free of rotatable elements. These central areas provide a point at which the user can establish a fixed connection to the ground.

However, these prior art solutions overlook the fact that providing a central gripping surface for stability also prevents the user from walking with a natural gait. In a normal walking motion, each foot is alternately placed forward and then pulled backward under and behind the user, with the last part of the motion causing the user to walk forward with the other foot. If the foot is prevented from moving behind the user's center of gravity, as would be the case due to friction with the central gripping surface of the known solutions, the user's gait becomes stilted and unnatural.

There is a need for a VR treadmill that enables truly omnidirectional movement while allowing the user to walk safely with a natural and comfortable gait, further enhancing immersion.

The present invention is to be seen in this context.

As an omnidirectional treadmill device to support a VR experience, the device comprises a concave platform with a regular arrangement of openings in which ball bearing elements are installed, the arrangement extending over the upper surface of the platform. The platform is supported by a frame which is connected to a freely rotatable body support to hold a user in a position above a central point of the platform. The combined use of the concave, ball-bearing covered platform and the body support allows the user complete freedom of movement in a way that allows their feet to roll on the floor of the platform in a way that feels natural. The rotating body support, which can also be referred to as a body support, can hold the user in place using a hip belt, for example. However, this is not just for safety. For an immersive and smooth running experience, you should lean forward into the belt. You are essentially running against the belt. This ensures that your feet roll back on their own.

Thus, according to one aspect, there is provided an omnidirectional treadmill apparatus comprising: a circular platform, wherein the platform has a concave profile with a central point forming the bottom of its upper surface, and wherein the upper surface has a regular array of circular openings distributed over its area; a plurality of spherical ball bearing elements, wherein each ball bearing element is installed in a corresponding opening of the top surface such that an upper portion of each ball bearing element is exposed and protrudes from the opening, and wherein each ball bearing element is configured to be able to rotate about any axis while installed in the opening; a frame, wherein the frame is configured to support the platform; and a body support mechanism, wherein the body support mechanism comprises a harness support coupled to the frame via a freely rotatable connection and configured to secure a person's body in place over the central point of the platform while allowing the supported person to rotate in any desired direction via the rotatable coupling to the frame.

In some embodiments, the frame comprises a central support placed below the central point of the platform, and the body support mechanism comprises a pair of arms pivotally connected to the central support and wrapping around the platform to hold the belt support in position above the platform. A harness support is understood to include all possible embodiments that can hold the user in position. In addition to belts, vests or any other holding devices can also be used.

In some embodiments, the frame is divided into a lower frame part, which supports the device on the floor, and an upper frame part, to which the running platform is attached. This subdivision is necessary in some embodiments because the arms of the rotating body support need their free space between the two frame parts to be rotatable.

In some embodiments, the openings in the top of the platform are cylindrical openings with a depth that is less than the diameter of the corresponding ball bearing elements so that the ball bearing elements protrude from them. The opening does not necessarily have to be cylindrical. All opening geometries that hold the balls in position and allow them to partially protrude can be used. This also includes spherical openings.

In some embodiments, the openings in the top of the platform have fastening devices to hold the corresponding ball bearing elements in the openings with minimal friction. These may take the form of a cover, among other things. This should include holes so that the balls continue to protrude from the top. One embodiment includes balls that lie in the opening up to at least half their diameter. The holes in the cover can then have a slightly smaller diameter than the diameter of the balls. This ensures that the balls remain in their holes.

In addition, the openings in the top of the platform can contain various secondary, smaller ball bearing elements that are arranged under the primary, larger ball bearing elements. This reduces the friction of the primary ball bearing elements.

In some embodiments, the ball bearing elements are coated with a lubricant.

In some embodiments, the ball bearing elements are arranged in concentric rings around the center of the upper surface of the platform.

Various measures can be taken to reduce the force required to make the balls rotate. One is, of course, the aforementioned use of lubricants. Furthermore, the smoother the balls, the lower the resistance. For example, a ball with a precision grade of G5 will run more smoothly than a ball with a precision grade of G100. Friction could also be further reduced by placing the balls over a small hole from which compressed air flows.

Furthermore, electric motors or compressed air flowing through a hole or holes below the balls could be used to make the balls rotate or break them in different ways. When using compressed air, the hole where the air flows through doesn't need to be directly below the center of the ball. This could also be done, but it would make it easier to rotate the balls in all directions and is already mentioned above. If the hole or holes are instead placed towards the outer side of the ball, the inwards rotation of the balls would be supported, while the outwards rotation would be slowed down. This could help to support the rotation at the right moment (start of the step) and also to slow it down at the right moment (end of the step). If you push away from the surface at the end of the step, it is advantageous if the balls rotate as slowly as possible or even not at all. This does not necessarily have to be achieved with electric motors or compressed air. The balls could also be made to rotate using magnetic fields. They can definitely be slowed down by magnetic fields.

To achieve the braking effect when pushing off (end of step), you could also ensure that the balls on the edge of the platform can only rotate in the direction of the center point. This means that they only rotate when you start the step, but not when you push off the platform again at the end of the step. This can be implemented in various ways. One possibility would be to change the shape of the balls so that they can only rotate in one direction. This could be achieved, for example, by providing the surface with features that only get stuck in a certain place by rotating in a certain direction.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a first isometric view of an example configuration of a treadmill device from above;

FIG. 2 shows a second isometric view of the example configuration shown in FIG. 1 from below;

FIG. 3 shows an isometric view of the example configuration of the treadmill device, with the ball bearing elements removed;

FIG. 4 shows a close-up of the top of the platform of the example configuration of the treadmill device, with the ball bearing elements removed;

FIG. 5 shows a close-up of the top of the platform of the example configuration of the treadmill device with the ball bearing elements installed;

FIG. 6 shows a cross-sectional view of several ball bearing elements;

FIG. 7 shows a top view of several ball bearing elements; and

FIG. 8 shows a foot with several axes of rotation. The orientation and alignment of these axes is merely an example.

### DETAILED DESCRIPTION OF PREFERRED EMBODIMENTS

In the figures and in the detailed description, common reference numerals are used to identify common elements. A person skilled in the art will readily recognize that the above figures are examples and that other architectures, modes of operation, sequences of operation and elements/functions may be provided and implemented without departing from the features and characteristics of the invention as set forth in the claims.

Exemplary embodiments are described in detail below to illustrate the principles of the invention. The exemplary embodiments serve to illustrate aspects of the invention, but the invention is not limited to any one embodiment. The scope of the invention includes numerous alternatives, modifications and equivalents; it is limited only by the claims.

For a better understanding of the invention, numerous specific details are given in the following description. However, the invention can be practiced according to the claims without some or all of these specific details. For the sake of clarity, a detailed description of technical material known in the technical fields related to the invention has been omitted.

The terminology used herein is merely descriptive of certain embodiments and is not to be construed as limiting the invention. As used herein, the term “and/or” includes all combinations of one or more of the associated listed elements. As used herein, the singular forms “one”, “a” and “the” include both the plural forms and the singular forms, unless the context clearly indicates otherwise. It is further understood that the terms “comprising” and/or “containing” and/or “including”, when used in this description, specify the presence of the specified features, steps, operations, elements and/or components, but do not exclude the presence or addition of one or more other features, steps, operations, elements, components and/or groups thereof.

The exposed treadmill allows omnidirectional movement for a user walking with a natural gait by having a concave platform with an upper surface completely covered by a series of ball bearing elements that holds and supports the user at a point in space above the center of the platform with a rotatable body support connected to a frame below. This allows the user to walk and even run in any direction without risking bodily injury, with a movement that feels natural enough that they may even momentarily forget they are in a VR experience.

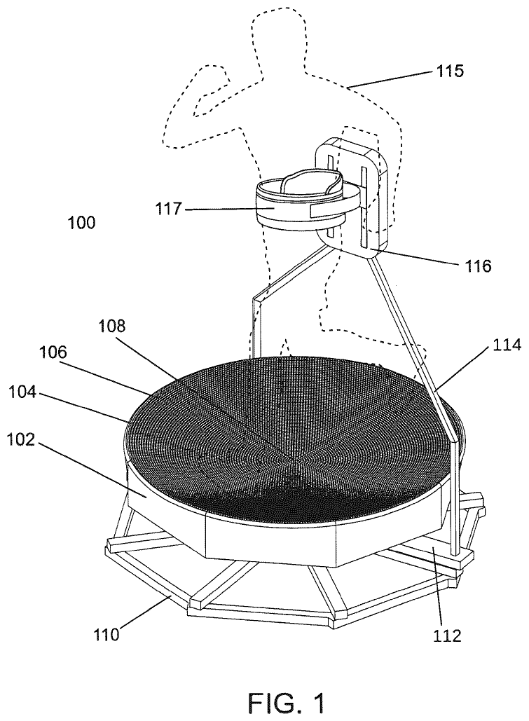

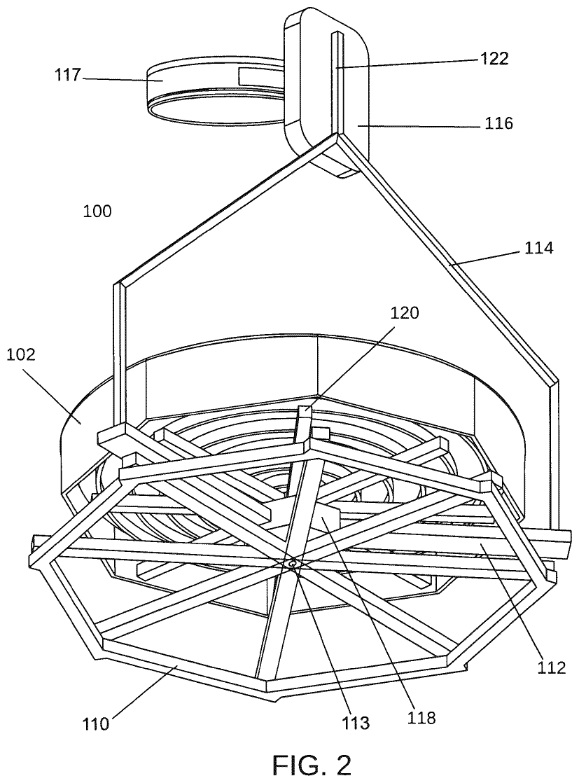

With reference to FIGS. 1 and 2, first and second isometric views of an example configuration of a treadmill device 100 according to the present description are shown from above and below.

As can be seen, the device 100 comprises a circular platform 102 with a concave profile. The upper surface 104 of the platform 102 is completely covered by a regular array or field of ball bearing elements 106 installed in openings 107 of the upper surface. In the present example, these openings 107 and ball bearing elements 106 are arranged in concentric circles around a central point 108 of the platform 102, but other arrangements are also conceivable. The only limitation is that they must each be close enough together to allow seamless rolling of the foot of a person being held, also referred to hereinafter as the user 115 or user 115, and that they must cover the upper surface.

The term “upper surface” as used herein refers exclusively to the portion of the platform on which a user 115 walks while attached to the treadmill. The statement that this surface is covered in its entirety means that both the central area and the curved sides of the upper surface are covered.

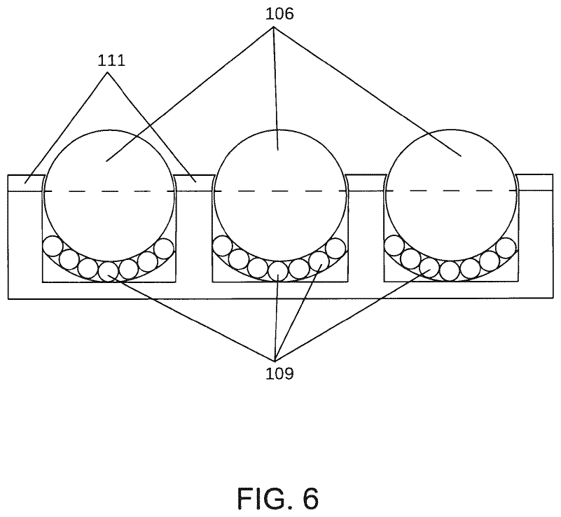

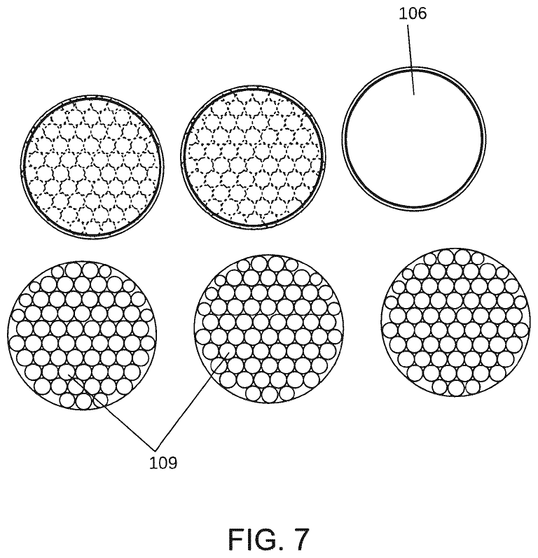

Each ball bearing element 106 is mounted in a corresponding opening 107 of the upper surface such that an upper portion of each ball bearing element 106 is exposed and protrudes from the opening 107. The ball bearing elements 106 are mounted such that they are freely rotatable about any axis within their openings. Various types of apertures 107 can be used, from simple cylindrical or spherical holes, the depth of which is less than the diameter of the balls, to more complex arrangements with smaller balls rolling with the main ball to reduce friction in the aperture 107. FIGS. 6 and 7 show an exemplary arrangement of the ball bearing elements/balls 106 and the smaller ball bearing elements/balls 109. FIG. 6 shows a cross-section and FIG. 7 a top view. Many other arrangements are possible. FIG. 6 also shows an example configuration of the cover 111.

The platform 102 is supported by a frame. In the present example, the frame comprises a lower frame segment 110, which supports the entire treadmill on the ground, and an upper frame segment 120, which connects the platform 102 to the lower frame 110. The upper and lower frames are connected to each other by an axle 113. This axle 113 runs through the center of the ball bearing, which is located inside the component 118. This ball bearing enables the rotation of the components 118, 112, 114, 116, 117 and 122, i.e. the body support.

To ensure that a user 115 does not lose balance on the ball bearings of the platform and can walk and run freely and safely in any direction on the treadmill without fear of falling and sustaining physical harm, the treadmill 100 also includes a body support mechanism that holds the user 115 in position above the center point 108 of the platform 102.

In the present example, the body support mechanism takes the form of a harness mount 116. The harness mount is pivotally connected to the frame below the platform 102 via a pair of arms 114 and a set of radially disposed supports 112. Together, the supports 112 form an anchorage point above the platform 102 that can rotate with the user 115 while holding the user in place. The arms 114 are connected to the harness mount 116 via the support 122, and the harness 117 can be attached to the front side.

A belt arrangement 117 shown in FIG. 1 may or may not be integrated into the belt holder 116. However, there must be something to hold the user 115 in place.

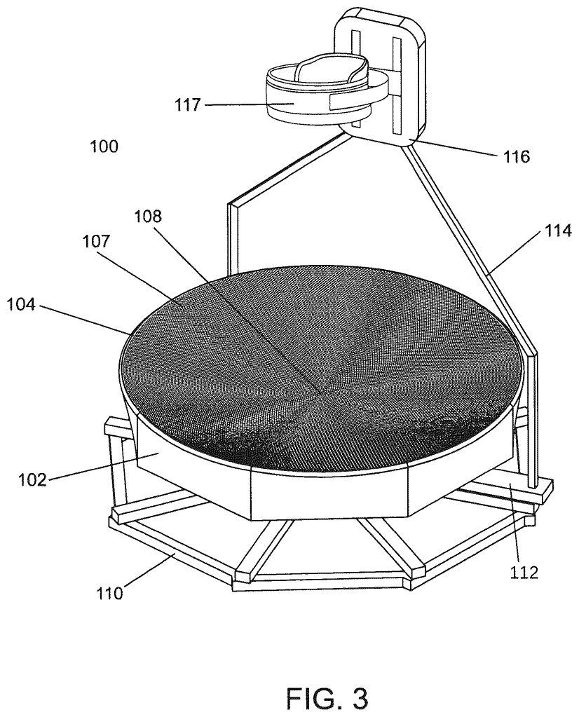

FIG. 3 shows another isometric view of the treadmill 100, in which the ball bearing elements 106 are removed from the platform.

In other examples, the treadmill may be supplied with the ball bearing elements 106 already installed in the openings 107 and with a separate cover to hold them in place. In this way, the purchaser no longer has to insert the balls themselves. If a cover 111 is used, as should be the case in practice, no additional cover is needed for shipping, as the balls are held in their hole by the cover 111.

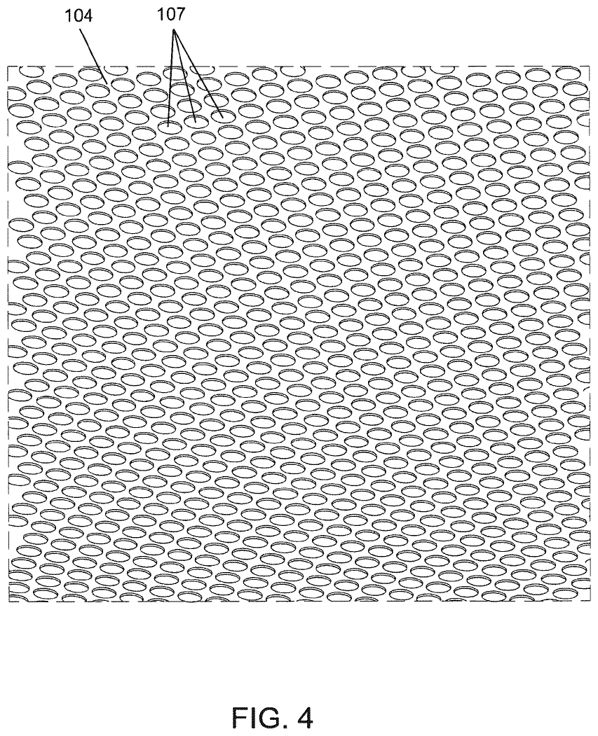

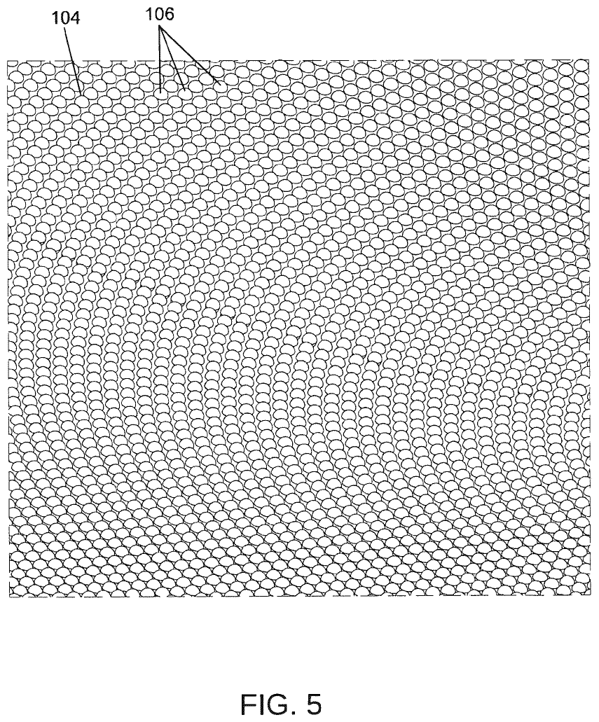

FIGS. 4 and 5 show close-up views of the upper surface of the platform of the example configuration with the ball bearing elements removed (FIG. 4) and installed (FIG. 5), respectively.

The curvature of the concave platform 102 means that gravity will cause the user's front foot 115 to roll down over the ball elements as he shifts his weight onto them, bringing him back to the center point. After passing the center point, the foot can now roll up the rear slope as far as is natural for its gait. The other foot follows the same offset movement pattern as in a normal running or walking movement. In this way, the user 115 can take full and natural steps. When the user 115 turns around, the arms of the body support turn with them and rotate around the center of the platform to keep the user 115 safely on the treadmill.

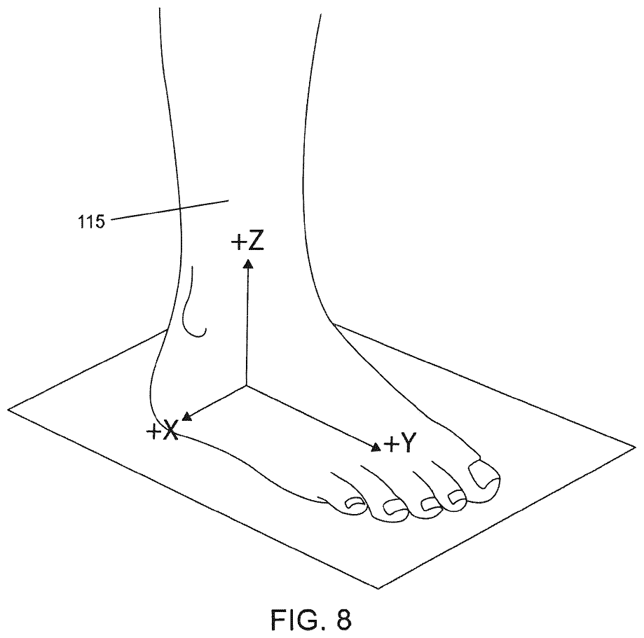

Various means can be used to track the movements of a user and convert them into corresponding VR movements. Camera tracking with multiple cameras arranged around the treadmill or placed on the treadmill is one way to track the movements. Other methods such as the use of IMU sensors, SLAM trackers, UWB technology, electromagnetic tracking, rotation measurement devices, Vive base stations and others are also possible. Several methods can also be combined with each other. The aim of this movement tracking should be to track and transmit the movement as the position and rotation of the shoes/feet in three-dimensional space. If you look at the position and rotation over time, you get the movement of the feet. A more technical and commonly used term for this form of tracking is 6DOF-tracking. 6DOF stands for six degrees of freedom, which means that the exact position and absolute orientation in space in all three spatial axes/dimensions (X, Y and Z) as well as its rotation around each of these axes (roll, pitch, yaw) is tracked. In theory, only the rotation around the Z-Axis (FIG. 8), also commonly referred to as yaw, is necessary for the control of the movement direction in the VR application through the feet. Therefore, 4DOF tracking consisting out of the position in space in all three spatial axes/dimensions (X, Y and Z) (=3DOF tracking), as well as its rotation around the yaw axis (Z-axis FIG. 8) is theoretically sufficient. But considering that in reality, most tracking systems will either only track 2DOF, 3DOF or 6DOF, it will be referred to in the further context as 6DOF tracking or three-dimensional tracking. But these can also only mean 4DOF tracking.

An emulator can be programmed using the information about the position and rotation of the feet. This emulator converts the information about the movements of the feet into a joystick movement. In other words, into movements in the VR application. A joystick movement, which is emulated in our case, consists of 2 components. The joystick movement direction and the joystick deflection amplitude, which measures how far the joystick is moved from its neutral position (the center point).

One advantage of our 6DOF tracking approach is that the feet can be used directly for directional control of the emulated joystick. To do this, both feet should have a forward facing vector. This points from the heel in the direction of the tip of the foot, like the Y-axis in FIG. 8. The two forward facing vectors should then be combined to form an overall direction vector. This can be done by vector addition or by creating the mean/average vector of the two vectors.

Information about the movement of the feet in three-dimensional space is also useful for emulating a backward movement. This makes it possible to determine when the foot is in the air and when it touches the treadmill surface. If this differentiation between the foot in the air and on the treadmill surface is too imprecise due to pure movement tracking with cameras, Inside-out tracking or other 6DOF tracking methods, for example, other sensors such as pressure sensors, distance sensors or contact sensors could also be used.

If the user 115 is running forwards, he moves his feet on the treadmill surface from the front or from the center to the back. However, if the user 115 is running backwards, they move their feet on the treadmill surface from the center towards the front. This refers to the movements on the treadmill surface. These must be differentiated from the movements in the air. This is because when running forwards, the movement in the air between the steps is also from the back to the front. And when running backwards, the movement in the air between the steps is also from the front towards the back. This means that if you cannot differentiate between movement in the air and movement on the treadmill surface, it becomes much more difficult to tell the difference between the two types of movement. A forward movement can therefore be initiated by moving at least one foot forwards in the air or backwards on the treadmill surface. A backward movement can therefore be initiated by moving at least one foot backwards in the air or forwards on the treadmill surface.

If it is not possible or desired to reliably distinguish between a movement in the air and a movement on the treadmill surface, alternative approaches for the backward movement would also be conceivable. On the one hand, the inclination of the foot upwards and downwards could be considered in order to distinguish when a forward or backward movement is being performed. The inclination of the foot is not the same as the previously mentioned control of the direction of movement through the rotation of the feet. When controlling the direction of movement, the inclination/rotation of the feet to the left and right is considered. Instead, what is meant here is the inclination/rotation upwards and downwards. This changes over the course of a step and could therefore be used to differentiate between forward and backward movement.

This difference is illustrated in FIG. 8. The inclination/rotation of the feet upwards and downwards refers to the rotation around the X-axis. The inclination/rotation of the feet to the left and right to control the direction of movement refers to rotation around the Z-axis. The fact that a right foot is shown in FIG. 8 has no meaning. It could also be a left foot.

Another alternative would be to use the fact that a step for a forward movement on the treadmill usually starts in front of or on the center point and only ends well behind the center point. In contrast, the step for a backward movement usually starts in the middle and ends further forward. However, the rear area is not used. This distinction can be used to differentiate between forward and backward movements.

The information about the movement of the feet in three-dimensional space is also useful for emulating a sideways movement. On the one hand, one or both feet can of course be rotated sideways. Since the overall direction of movement is controlled by the orientation of the feet, rotating one or both feet to the side leads to a rotation of the overall direction of movement to the side. You could also specify an angle at which the sideways movement is increased. For example, if the right foot rotates more than 70° to the right, an increased sideways movement could be initiated. Although the overall direction vector has already rotated to the right in this case, the initiation of the increased sideways movement means that this rotation is increased to such an extent that it is for example approximately 90° to the forward direction.

The omnidirectional treadmill is used with 6DOF tracking technology that not only detects forward and backward movements, but also complex sideways movements of the user's feet, and translates these precisely into the virtual reality application. This is made possible by continuously measuring the foot positions and their directions of movement, whereby different methods can be used to determine the angular relations for sideways movements.

One method for sideways movement is to measure the angle between the foot's forward vector and the direction of movement vector. The forward vector is the vector that runs from the back of the foot to the toe, i.e. like the Y-axis shown in FIG. 8. The motion direction vector is the vector that is created when you continuously draw a vector between two positions of the foot at two points in time. If a sideways movement takes place that exceeds a predefined threshold for the angle between the forward vector of the shoe and the motion direction vector, this movement is emulated as a sideways movement with the corresponding angle in the VR application.

Another way to get an angle for the sideways movement is to measure the angle between the overall direction vector (from combined forward facing vectors of both feet) and the direction of movement of a foot. The direction of movement is the vector that is created when you continuously draw a vector between two positions of the foot at two points in time. If this angle exceeds a specified threshold, a sideways movement with the corresponding angle occurs in the VR application.

The third way to get an angle for the sideways movement is to use the angle between the overall direction vector (from combined forward vectors of both feet) and the vector connecting the center of the treadmill with the position of the foot. If this angle exceeds a specified threshold, a sideways movement with the corresponding angle occurs in the VR application.

In all three approaches to measuring the angle of sideways movement, the measurement is continuous and allows the user to move sideways at any angle.

In all three approaches, the overall direction vector, which is created by combining the forward facing vectors of both feet, serves as the starting point (zero point) for setting the measured angle and making the corresponding directional change. For example, if a sideways movement is detected with an angle of 50°, the overall direction vector is adjusted by this angle, resulting in a sideways movement of 50° relative to the overall direction vector in the VR application.

So if a sideways movement is detected that exceeds a specified sideways movement angle threshold, the original overall direction vector is temporarily ignored and the overall direction vector jumps by the measured angle, i.e. by 50° in the example given. After the angle between the sideways movement and the overall direction vector falls below a specified threshold, the system switches back to the original overall direction vector, or the overall direction vector jumps back so that it becomes the combined vector of the forward vectors of both feet again. This ensures that the user's basic orientation and original direction of movement are maintained in the VR application as soon as normal forward or backward movements resume.

The system is also able to use a combination of the approaches described above to ensure optimal accuracy and user experience. This allows for flexible adaptation to different VR applications and individual user preferences.

It also makes sense to differentiate between feet in the air and feet on the treadmill surface when moving sideways. This is because it is also possible to differentiate in which direction the user is moving in the VR application. However, instead of distinguishing between forwards and backwards, a distinction is made here between left and right. A leftward movement can therefore be initiated by moving at least one foot from right to left in the air or from left to right on the treadmill surface. A rightward movement can therefore be initiated by moving at least one foot in the air from left to right or from right to left on the treadmill surface.

The emulator determines the joystick amplitude by accurately calculating the speed of the feet and using thresholds and filters to avoid unwanted stopping due to the feet changing direction at the end of a step. The speed of the feet is accurately calculated by tracking with at least 3DoF trackers, which measure the position of the foot at different points in time. The speed is then determined by dividing the change in position over time. This is done by calculating the difference between two consecutive positions (in the X, Y and Z coordinates) and dividing these differences by the time difference between the two measurements. The result shows how fast the foot is moving. This method is significantly more accurate than speed calculations based on acceleration data (which are common in the state of the art/among competitors). This is because the latter require an integration of the acceleration over time to obtain the speed. This integration process inevitably leads to accumulated errors, especially if the acceleration signal has noise or bias. Every small error in the acceleration measurement leads to larger errors in the speed calculation over time.

The emulator is configured to calculate the amplitude of the joystick deflection (joystick deflection amplitude) based on the measured speed of the user as described previously and such that the speed of the user in the associated virtual reality application is linearly scaled with the joystick deflection amplitude. In this scaling, a joystick deflection of 0% corresponds to a player movement of 0 km/h in the VR application, while a joystick deflection of 100% corresponds to the user's maximum speed in the associated VR application. If the speed is scaled linearly in the VR application and the maximum possible speed in the VR application is at least equal to the maximum speed that the user can actually achieve on the treadmill, the full range of speeds is covered and thus the user's speed can be accurately transferred from the minimum to the maximum to the VR application. So, for example, if the maximum possible speed in the VR application is 50 km/h, the user can run as fast as he wants and the speed will be accurately transmitted even during a full sprint. If, for example, the user only runs at 25 km/h, the software emulates a joystick amplitude of 50%, which is transmitted to the VR application as 50% of the maximum possible speed (50 km/h) and thus also results in a speed of 25 km/h in the VR application. Since many VR applications allow for a lower maximum speed than most people can achieve on a treadmill, they can be modified to increase the maximum speed and thus enable the full range of speeds. This modification is not necessary for many VR applications, since it is perfectly acceptable or even desirable in the application to only reach a limited maximum speed. For example, if the maximum speed in a VR application is only 10 km/h, the scaling of the joystick amplitude in the emulator can easily be adjusted so that the 100% joystick amplitude is reached exactly when the user also reaches 10 km/h on the treadmill.

The emulator is also configured to adjust the joystick amplitude so that common joystick deadzones in games, for example a deadzone of 20%, are bypassed. This is achieved by adjusting the start of the joystick amplitude (0%) to the end of the dead zone, effectively ignoring the first 20% of the joystick movement and scaling the subsequent movements accordingly.

The position of the feet in three-dimensional space (3DOF) is not only important for accurately determining the speed. It is also needed to define certain areas of the treadmill as zones with certain properties. For example, controlling the overall direction vector by combining the forward vectors of both feet ensures that when the foot pushes off the treadmill surface at the end of each step, the foot usually makes a slight outward swinging motion. This swinging motion causes the overall direction vector to move left and right when you simply want to walk straight ahead. To dampen these unwanted movements while maintaining precision in foot direction control, a region should be declared in which the rotation of the feet has less, up to no, effect on the overall direction vector. This region should be customizable in its positioning, geometry, and damping intensity to suit the individual needs of the user. In addition, this area must rotate with the overall direction vector in order to always maintain the same orientation relative to the user. Typically, this area is located in the rear half of the treadmill (considering the direction in which the overall direction vector points as the front), since it is in this area that the foot performs a pivoting movement when pushing off the treadmill to take a step.

In the long term, it makes sense to implement parts or even the entire emulator and possibly even the tracking of the movement with the help of neural networks/artificial intelligence. This means that, on the one hand, computer vision could be used to obtain information about the movement and rotation of the feet in the first place. In other words, to track the feet. Then the emulator or parts of it could also be implemented using a neural network/artificial intelligence. The neural network would be trained to distinguish between different types of movement, such as forwards, backwards or sideways. It could also be trained to determine the overall direction of movement from various factors. Here too, the alignment of the feet remains the most important factor.

Other methods are also possible for all the tracking and emulation procedures listed.

By tracking the movements of the feet in three dimensions, it would also be possible to implement so-called “full-body tracking”. For this purpose, it would also make sense to track additional points such as the knees or hips. However, it would also be possible to ensure that the movements of the feet are reflected in the VR application without these additional points. In this case, however, it should perhaps be called “foot tracking”. This would allow the user or other users 115 to see their feet and their movements in the VR application and, for example, dance or kick. It is important to understand that only the movements of the feet or body parts themselves are transmitted. These movements must be distinguished from the movements generated by the emulation. The emulated movements are the movements of the user 115 in virtual space. In other words, the movement of the user 115 from point A to B. These movements must therefore be considered separately from each other. You can only transfer the foot movements if, for example, you only want to dance on the spot. In most cases, however, only the emulated movements are required, as most applications involve getting from point A to point B. In other words, moving through the virtual world. Of course, you can also transfer both the movements of the feet and the emulated movements.

It is therefore proposed that the omnidirectional treadmill device has a means of detecting the movement, including rotation, of a user's feet 115 in three-dimensional space (4DOF/6DOF tracking). The hardware for this can be attached or placed on the shoes or on the platform or anywhere else. Various options can also be combined.

It is advantageous if the device is designed to differentiate between movements in the air and movements on the treadmill surface. For this purpose, the platform or the shoes can have at least one additional sensor that detects the contact of the user's feet 115 with the platform.

An emulator that converts information about the movements of the feet into a joystick movement for control in a VR application is advantageous.

The emulator can determine the direction of movement based on an overall direction vector generated by combining the forward facing vectors of both feet.

It is advantageous if the emulator emulates movements in the forward, backward or sideways direction based on the movement and/or inclination/rotation of the feet and/or contact of the feet with the treadmill.

It is also proposed to use neural networks or artificial intelligence for motion tracking and/or emulation.

It is advantageous if the device enables full-body tracking or feet tracking, whereby in addition to the user's feet, 115 other body points such as knees or hips can be tracked.

Unless otherwise defined, all terms used herein (including technical terms) have the same meaning as commonly understood by one skilled in the art to which this invention pertains. It is further understood that terms as defined in dictionaries in common use should be construed to have a meaning consistent with their meaning in the context of the relevant prior art and the present disclosure, and should not be construed in an idealized or overly formal sense except as expressly defined herein.

The illustrated embodiments are illustrative and non-restrictive. While specific configurations of the service provider customer experience verification system have been described in specific terms with reference to the illustrated embodiments, it will be understood that the present invention can be applied to a variety of solutions that fit within the scope and spirit of the claims. There are many alternative ways to implement the invention.

It will be understood that the embodiments of the invention described herein merely illustrate the application of the principles of the invention. Reference to details of the embodiments illustrated is not intended to limit the scope of the claims, which themselves recite those features which are considered essential to the invention.

What is claimed is:

1. An omnidirectional treadmill apparatus (100) comprising
a circular platform (102), the platform having a concave profile with a central point (108) forming the bottom of its upper surface, and the upper surface (104) having a regular array of circular openings (107) formed across its upper surface (104),
the treadmill allowing omnidirectional movement for a user walking with a natural gait, in that the platform has an upper surface completely covered by a series of ball bearing elements arranged with the smallest possible gaps and around the center (108) of the upper surface (104) of the platform (102), the ball bearing elements being so close together as to allow seamless rolling of a foot,
wherein the statement that said surface is covered in its entirety means that both the central area and the curved sides of the upper surface are covered,
a plurality of spherical ball bearing members (106), wherein each ball bearing member (106) is installed in a corresponding opening (107) of the upper surface (104) such that an upper portion of each ball bearing member (106) is exposed and protrudes from the opening (107), and wherein each ball bearing member (106) is configured to rotate about any axis while installed in the opening (107);
a frame (110, 120) configured to support the platform (102) and divided into a lower frame portion supporting the apparatus on the ground and an upper frame portion to which the platform is attached,
a body support mechanism comprising a harness mount (116) coupled to the frame (110, 120) via a freely rotatable connection and configured to secure the body of a person (115) in place over the center point (108) of the platform (102) while allowing the supported person (115) to rotate in any desired direction via the rotatable connection to the frame (110, 120);
wherein the platform (102) is supported by the frame and the lower frame portion (110) supports the entire treadmill on a floor and the upper frame portion (120) connects the platform (102) to the lower frame portion (110),
wherein the upper and lower frame parts are connected to each other by an axle (113),
wherein said axis (113) extends through the center of a ball bearing which allows rotation of the body support (118, 112, 114, 116, 117 and 122) relative to the platform (102).

2. The omnidirectional treadmill device (100) according to claim 1, wherein the frame (110, 120) comprises a central support arranged below the central point (108) of the platform (102), and the body support mechanism comprises at least one arm rotatably coupled to the central support and winding around the platform (102) to hold the belt support (116) in position above the platform (102).

3. The omnidirectional treadmill device (100) according to claim 1, wherein the belt holder (116) comprises an integrated belt (117).

4. The omnidirectional treadmill device (100) according to claim 1, wherein the frame (110, 120) is divided into a lower frame part (110) which supports the device on the ground and an upper frame part (120) which holds the platform (102) in position.

5. The omnidirectional treadmill apparatus (100) according to claim 1, wherein the openings (107) in the upper surface (104) of the platform (102) are openings having a depth which is less than the diameter of the corresponding ball bearing elements (106), whereby the ball bearing elements (106) protrude therefrom.

6. The omnidirectional treadmill apparatus (100) according to claim 1, wherein the apertures (107) in the upper surface (104) of the platform (102) comprise mounting arrangements to retain the respective ball bearing elements (106) in the apertures (107) with minimal friction.

7. The omnidirectional treadmill apparatus (100) according to claim 1, wherein the apertures (107) include a plurality of secondary, smaller ball bearing elements (109) arranged below the main ball bearing element (106) of each aperture (107).

8. The omnidirectional treadmill device (100) according to claim 1, wherein the ball bearing elements (106) are coated with a lubricant.

9. The omnidirectional treadmill device (100) according to claim 1, wherein it comprises an emulator which converts information about the movements of the feet into a joystick movement for control in a VR application.

10. A method for using the omnidirectional treadmill device according to claim 1, wherein a movement is tracked as position and rotation of the shoes or feet in three-dimensional space and observed over time.

11. The method according to claim 10, wherein an emulator is used to determine the direction of movement based on an overall direction vector obtained by combining the direction vectors of both feet pointing from the heel towards the toe of the foot.

12. The method according to claim 10, wherein also for the emulation of a backward movement the information about the movement is used as position and rotation of the shoes or feet in three-dimensional space.

13. The method according to claim 10, wherein additional sensors such as pressure sensors, distance sensors or contact sensors are used to determine when the foot is in the air and when it touches the treadmill surface.

14. The method according to claim 10, wherein the information about the movement is also used for the emulation of a sideways movement as the position or rotation of the shoes or feet in three-dimensional space.

15. The method according to claim 10, wherein neural networks or artificial intelligence are used for motion tracking and/or emulation.

16. The method according to claim 10, wherein full-body tracking or feet tracking is enabled by default.
